(19) United States
(12) Patent Application Publication
(10) Pub. No.: US 2016/0000096 A1
(43) Pub. Date: Jan. 7, 2016

(54) APPARATUS AND METHOD FOR METERED SHAPING DISPENSING OF MASS BODIES FROM PUMPABLE MASSES

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); NIELS KAMPERMANN, AA ALMERE (NL)

(21) Appl. No.: 14/759,521

(22) PCT Filed: Jan. 2, 2014
(86) PCT No.: PCT/EP2014/050007

§ 371 Date: Jul. 7, 2015

(30) Foreign Application Priority Data
Jan. 7, 2013 (AT) A8/2013

(51) Int. Cl. A21C 11/16; A23G 3/20; A21C 14/00; A23G 3/02

(52) U.S. Cl. CPC A21C 11/16; A23G 3/0247; A23G 3/2015; A21C 14/00

(57) ABSTRACT

A nozzle configuration for the metered, shaping dispensing of mass bodies from pumpable, viscous or doughy masses includes a mass supply line for supplying the mass through a mass outlet opening into a separating region located outside the mass supply line. A gas nozzle configuration is provided for delivering one or more gas jets directed onto the mass located in the separating region and for the shaping separation of the mass body. An apparatus having at least one nozzle configuration and a method for the metered, shaping dispensing of mass bodies are also provided.

The invention relates to a nozzle arrangement, an apparatus and a method for the metered, shaping dispensing of mass bodies from pumpable, viscous or doughy masses and the like.

According to the prior art, pumps are known in food technology for conveying viscous, pumpable masses such as, for example, dough, creams, frothed creams, ice creams etc. in which a mass supply line for the metered dispensing of the masses is closed at regular intervals to form a mass body. A disadvantage with conventional apparatus is that the viscous masses at least partially adhere to the closure apparatus during closure and the mass body therefore does not have a clearly defined cutting edge but a thread-like continuation. This effect occurs in particular with soft flowable masses having relatively low viscosity.

Furthermore, it is known according to the prior art to blow out the mass supply line for conveying the mass to separate a mass body by means of air pressure. A disadvantage with this apparatus is that the air pressure substantially acts in the dispensing direction of the mass body. The form of a thread-like continuation of the mass body is certainly avoided by blowing out. However, a disadvantage is the effect that the air pressure uncontrollably deforms the cutting region of the mass body and in particular curves it inwards.

It is the object of the present invention to provide an apparatus and a method for the metered shaping dispensing of mass bodies from pumpable, viscous masses, which enables an exact metering, an exact shaping and an exact cutting of the mass body from the mass. Furthermore it is the object of the invention to provide an apparatus which is as simple as possible, favourable and maintenance-free.

All these objects can be summarized under the object of efficient, metered, shaping dispensing.

The object according to the invention is solved whereby a gas nozzle arrangement is provided for delivering one or more gas jets directed onto the mass located in the separating region and for the shaping separation of the mass body.

It can advantageously be provided that a gas nozzle arrangement is provided for delivering one or more gas jets directed onto the mass located in the separating region and for the shaping separation of the mass body.

It can advantageously be provided that the gas nozzle arrangement comprises a gas nozzle which is adapted for delivering a self-intersecting gas jet, that the gas nozzle arrangement comprises a plurality of nozzles which are adapted for delivering gas jets directed towards one another, that the direction of the gas jet in the region of the gas nozzle outlet differs from the dispensing direction of the mass conveyed from the mass supply line into the separating region, and that the gas jet or the gas jets run transversely to the dispensing direction of the mass and/or that the gas jet or the gas jets run in a cross shape or follow the shape of a double cone, a hyperboloid, a single-shell hyperboloid or a hyperboloid of rotation.

Further advantageous features are that the mass is advanced as a free jet in the separating region, that the gas jet or jets in the separating region are directed as a free jet outside the mass supply line onto the mass and/or the mass body, wherein the free jet of the gas jet is jet-guided or wall-guided, that the mass, the separating region and/or the mass supply line is surrounded by a gas nozzle outlet or by a plurality of gas nozzle outlets, that the gas nozzle outlet extends substantially annularly in the region of the separating region around the mass, that the gas nozzle has a tapering section in the direction of the gas nozzle outlet for focusing of the gas jet and/or that the gas nozzle outlet is designed as an annular gap, in particular as an annular gap free from interruptions.

According to further advantageous embodiments, it can be provided that a distributor chamber is provided for distributing compressed gases, which is connected to the pressure supply line and to the gas nozzle, that the distributor chamber extends annularly around the mass supply line, that the mass supply line can be closed partially or completely by a closure to influence the mass flow of the mass, that the closure comprises a movable piston, that the closure and/or the piston are disposed in the mass supply line and/or that the piston has a sealing region which can be brought into operative contact with a sealing region of the mass supply line for closing the mass supply line.

Furthermore, the object according to the invention is solved by an apparatus for the metered, shaping dispensing of mass bodies from pumpable, viscous masses such as dough, edible creams, ice cream and the like, characterised in that one or more nozzle arrangements according to the invention are provided.

The apparatus is preferably characterised in that a transport surface is provided for transporting the mass bodies separated from the mass in a shaping manner, that a plurality of nozzle arrangements are provided, which are disposed adjacent to one another in the region of the transport surface, that a compressor is provided for compressing a gas such as, for example, air and that the compressed gas is supplied via one or more pressure supply lines to the nozzle arrangements and in particular to the gas nozzle arrangements and/or that means for regulating the gas mass flow such as, for example, a regulating valve, a flow regulator and/or a pressure regulator are provided.

Furthermore, the object according to the invention is solved by a method for the metered, shaping dispensing of mass bodies from pumpable, viscous masses characterised by the following steps: a mass is conveyed in a mass supply line to a mass outlet opening, the mass is conveyed through the mass outlet opening from the mass supply line into a separating region, the mass is cut and shaped by a gas jet in the separating region so that a mass body is produced.

The method preferably comprises the steps that the mass is cut and shaped by the gas jet outside the nozzle arrangement, that the mass and the gas jets impinge upon one another as free jets for separation of a mass body from the mass and/or that the gas jet or the gas jets run transversely to the dispensing direction of the mass and/or substantially in a cross shape.

According to the present invention, the apparatus is suitable for dispensing one or more mass bodies in a metered and shaping manner. For metering the mass flow of the mass is interrupted in selectable and/or predefined intervals. Due to the interruption of the mass flow, individual mass bodies of desired size and/or desired mass are formed. The size and the weight of the output mass bodies can be controlled by means of suitable control of the apparatus.

For the shaping dispensing, it can be provided according to the invention that the mass is cut by a closure and/or a gas nozzle. In this case, the gas nozzle is in particular adapted to prevent trailing of thread-like continuations of the mass body towards the supply line. According to the invention, the mass body should be shaped along a desired contour, e.g. rounded. This is in particular solved by using a gas jet to cut the mass body from the mass or the closure and/or to shape it. The direction of the gas jet preferably runs transversely to the dispensing direction of the mass body. As a result of the nozzle arrangement according to the invention comprising a gas nozzle arrangement as well as the apparatus according to the invention comprising a nozzle arrangement, the desired shape is given to the mass body.

The direction of the gas jet in this case means the direction of a stream filament of the gas jet. In an annular arrangement of the gas nozzle arrangement, the gas jet or jets have a plurality of directions. Preferably the direction of each gas jet at least on emergence from the gas nozzle deviates from the direction of dispensing of the mass or the mass body in the separating region.

Transverse to the dispensing direction is defined in that the gas jet for the most part does not run parallel to the dispensing direction of the mass. In particular, transverse means a direction in which a cutting of the mass body by the mass is made possible.

Preferably the gas nozzle arrangement and the gas nozzle are operated with air. To this end a compressor is provided which compresses air and guides it via a gas supply line to the gas nozzle arrangement.

The cutting and shaping of the mass body is preferably accomplished by the gas jet which is present as a free jet. A process is designated as cutting or shaping by a free jet in which the deformation of the mass is accomplished definitively or completely by the gas jet. In contrast to a blowing out of a tube, in the present invention the cutting takes place outside the nozzle and outside the mass supply line. To this end, in the separating region, i.e. in that region in which the mass leaves or has left the mass supply line, the mass is cut as a free jet by the gas jet or jets which also emerge from the gas nozzle as a free jet. The free jet of gas can in this case be beam-guided, i.e. substantially without the influence of solid objects, or wall-guided, i.e. designed to be guided along a solid surface.

The gas nozzle arrangement can be annular, annular-segment-shaped or be disposed in sections around the outlet region or the mass. For uniform distribution of the compressed gas along a plurality of, or a single annular nozzle, a distributor chamber can be provided into which the compressed gas coming from the compressor is introduced. In this distributor chamber, the compressed gas is distributed and, for example, passed via holes or directly to the nozzle or to the nozzles of a nozzle arrangement.

A spatial-body or spatial-surface shaped gas jet is produced by an oblique annularly disposed nozzle. This follows, for example, a double cone, a hyperboloid, a single-shell hyperboloid or a hyperboloid of rotation, where the axes of symmetry of the geometrical shapes run substantially parallel or congruently to the dispensing direction of the mass.

It can further be provided that two or more gas nozzles directed towards one another are disposed around the separating region. As a result of the symmetrical arrangements, a lateral transverse deformation of the mass body can be prevented.

The invention is explained further hereinafter with reference to specific exemplary embodiments.

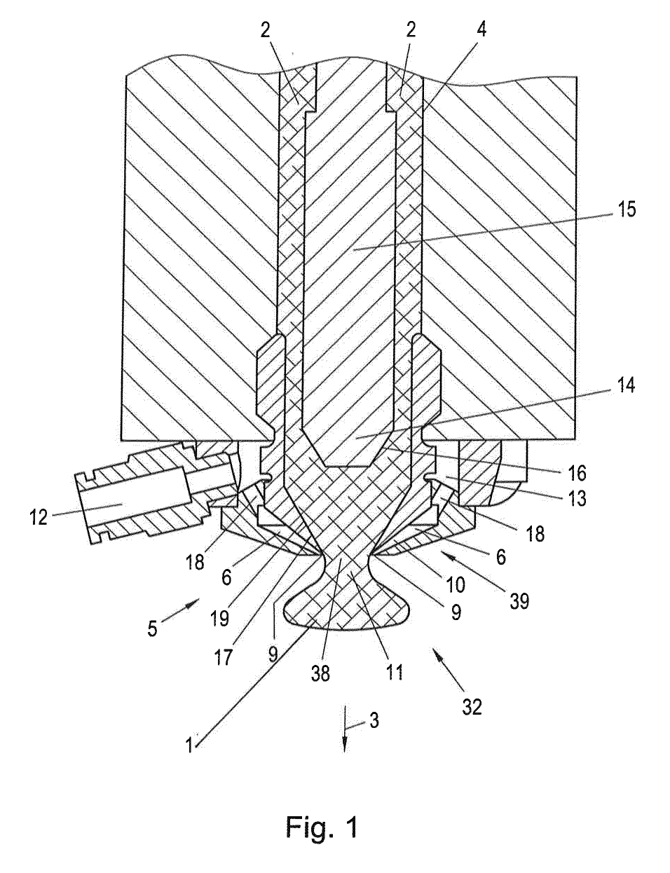

FIG. 1 shows a schematic sectional view of the nozzle arrangement of the apparatus according to the invention in a first position.

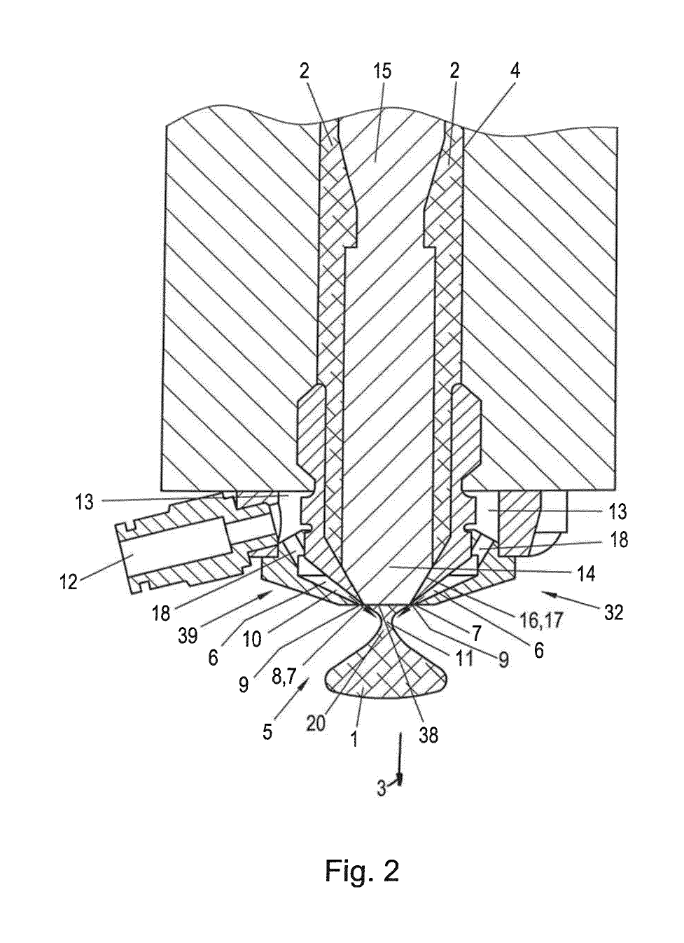

FIG. 2 shows a sectional view of the nozzle arrangement of an apparatus according to the invention in a second position.

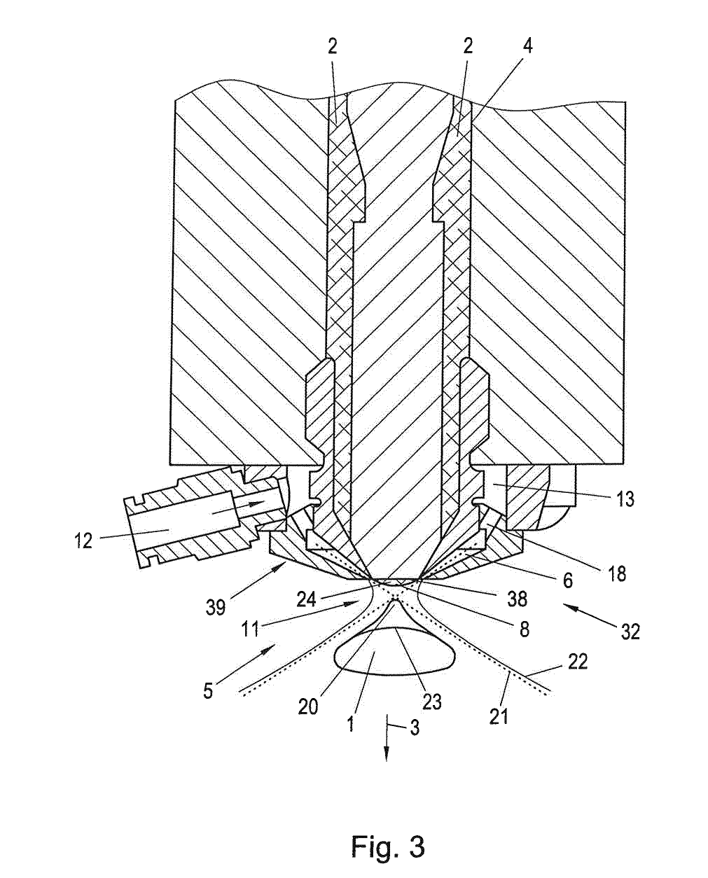

FIG. 3 shows an apparatus according to the invention in a third position.

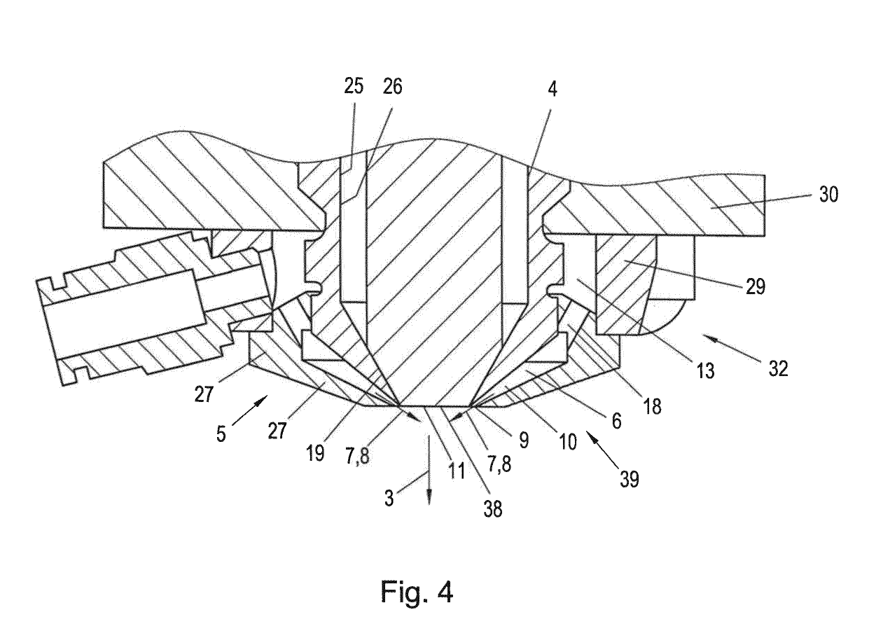

FIG. 4 shows a schematic detailed view of a section of an apparatus according to the invention.

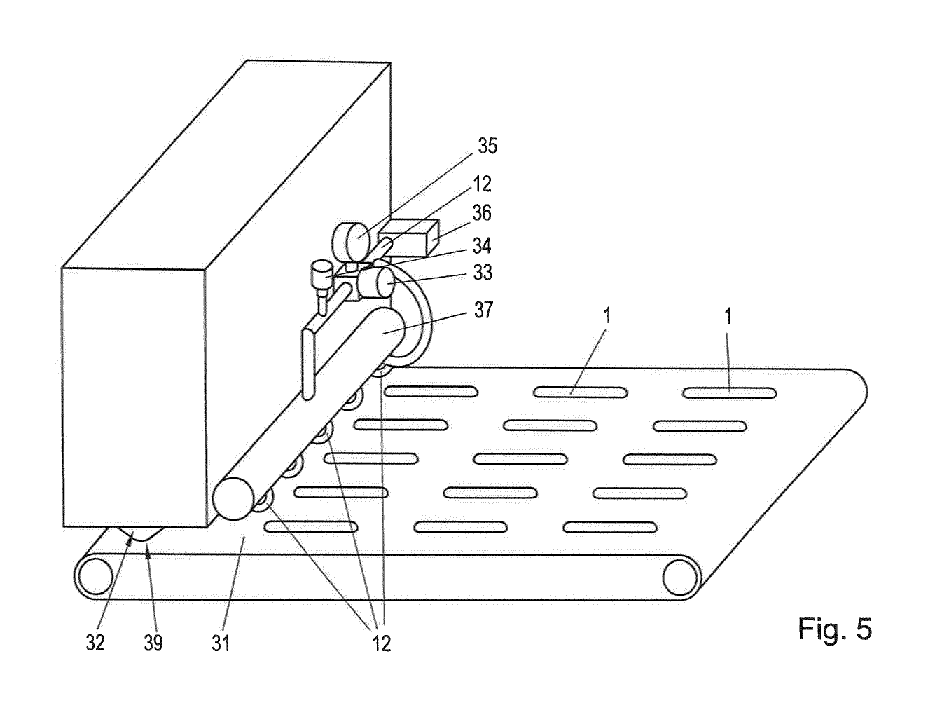

FIG. 5 shows a schematic view of an apparatus according to the invention.

FIG. 1 shows an embodiment of the apparatus according to the invention, in particular the nozzle arrangement 32, with a mass supply line 4 for supplying a mass 2 into a dispensing region 5. In this case, the mass 2 is conveyed via the mass supply line 4 through a mass outlet opening 38 into the separating region 11. A gas nozzle arrangement 39 is provided in the dispensing region 5. The gas nozzle arrangement 39 comprises one or more gas nozzles 6. The present gas nozzle 6 has a tapering, wedge-shaped section 10 which opens into the gas nozzle outlet 9. Preferably the housing is designed to be tapering in the direction of the gas nozzle outlet 9. A pressure supply line 12 is provided for supplying the gas, in particular compressed air. In the present embodiment, this opens into a distributor chamber 13 which extends annularly around the mass supply line 4 and is connected at several points or directly to the gas nozzle 6. In the present embodiment, a plurality of distributor holes 18 are provided, which extend from the distributor chamber 13 into the gas nozzle 6. In the dispensing region 5 the apparatus has the separating region 11. In this region the mass 2 emerges from the mass supply line 4 and is advanced there preferably by the after-flowing mass or by gravity as a free jet. The direction of advancement here substantially follows the dispensing direction 3. In the present embodiment of FIG. 1, the mass supply line 4 also has a tapering region 19. In this conically converging region a deflection of the dispensing direction 3 is optionally provided. However, the conveyance of the mass 2 and the mass body 1 substantially follow the dispensing direction 3 shown.

The sealing region 17 of the mass supply line is provided at the tapering region 19 of the mass supply line 4. Furthermore, a closure 14 is provided via which the mass supply line 4 and the conveyance of the mass 2 can be influenced or stopped. To this end, the closure 14 has a sealing region 16. The sealing region 16 of the closure 14 and the sealing region 17 of the mass supply line 4 can be brought into operative contact by means of a suitable control in order to stop or at least reduce the conveyance of the mass 2. In the present embodiment the closure 14 is executed by a piston 15 which is disposed in the mass supply line 4. In the open position shown, the piston 15 is surrounded or flushed along its lateral surface by the mass 2. As a result of axial displacement, in particular through displacement along the dispensing direction 3 in the direction of the separating region 11 or in the direction of the dispensing region 5, the sealing region of the closure can be brought into operative contact with the sealing region of the mass supply line. To this end the piston 15 has a conical, cone-shaped sealing region 16. The mass supply line 4 has a conical, tapering cone-shaped sealing region 17. Through the annular, linear or surface contact of the two sealing regions 16, 17, the conveyance of the mass 2 can be stopped or interrupted.

In the position shown in FIG. 1, the mass 2 is conveyed into the dispensing region 5. The piston is located in the withdrawn position. The closure 14 is thus opened and enables a conveyance of the mass 2 into the dispensing region. The gas nozzle 6, the distributor chamber 13 configured as an annular chamber and the pressure supply line 12 are filled with a gaseous medium, in particular with air. According to the pressure in FIG. 1 the pressure of the gaseous medium in the gas nozzle 6 corresponds to ambient pressure. Consequently, substantially no gas exchange takes place between the gas nozzle 6 and the outer region, in particular the dispensing region 5 or the separating region.

The mass 2 has emerged in the dispensing region 5 in a bulbous manner and can, for example, be applied to a moving or fixed surface or a carrier body. The mass body 1 is formed and shaped from this bulbous region by the steps according to the method.

FIG. 2 shows the apparatus from FIG. 1 but in a second position. In this position the closure 14, in particular the piston 15, is displaced in the direction of the dispensing region 5 or in the direction of the mass outlet opening 38. In so doing, the sealing region 16 of the closure 14 is pressed onto the sealing region 17 of the mass supply line 4. As a result of the surface, linear or annular abutment of the two sealing regions 16, 17, the mass supply line 4 is closed and the conveyance of the mass 2 of the mass supply line 4 into the separating region 11 is interrupted. In the position shown compressed gas flows through the pressure supply line 12 into the distributor chamber 13. The distributor chamber 13 extends substantially annularly around the mass supply line 4. Furthermore, the distributor chamber 13 has distributor holes 18. The distributor holes 18 connect the distributor chamber 13 to the gas nozzle arrangement 39 or the gas nozzle 6. The gas flows through the distributor holes 18 into the gas nozzle 6, further through the tapering section 10 in order to subsequently emerge as gas jet 7 or as gas jets 7 through the gas nozzle outlet 9. The gas jet 7 is directed onto the mass 2 or a region of the mass body 1. The focused gas jet 7 is guided in such a manner into the separating region 11 that it is possible to cut the mass body 1, preferably transversely to the dispensing direction 3.

In the diagram in FIG. 2 the mass body 1 has a continuation 20. This thread-like continuation 20 is formed by cohesion forces and/or adhesion forces in the viscous mass 2.

The diagram in FIG. 2 corresponds to the beginning of the cutting process by the gas jet 7.

FIG. 3 shows the same apparatus as in FIGS. 1 and 2 but in a third position. The apparatus in turn comprises a mass supply line 4 for supplying a mass 2 into a dispensing region 5. In the position in FIG. 3 the mass supply line 4, in particular in the tapering region 19 of the mass supply line 4, is closed by the closure 14. Consequently, the conveyance of the mass 2 is stopped. The mass has at least partially emerged from the mass supply line 4 in order to form a mass body 1. This mass body 1 is cut or separated according to the invention by the gas nozzle arrangement 39 and the gas jet 7 or the gas jets 7. To this end, compressed gas, in particular air, is passed through a pressure supply line 12, optionally a distributor chamber 13, with connected distributor holes 18 into the gas nozzle arrangement 39. The gas nozzle arrangement 39 is configured in such a manner that the gas jet impinges upon the mass 2 transversely to the dispensing direction 3 of the mass body 1 or the mass 2. In the dispensing region, in particular in the separating region 11, the mass 2 is present as a free jet. This free jet is cut and/or processed in a shaping manner by the gas jet 7. In the present embodiment, the gas nozzle arrangement 39 is disposed in such a manner that the gas jet is guided substantially conically onto the mass 2 and/or the mass body 1. The direction of the gas jet 7 therefore substantially follows a double cone 21, which is indicated schematically as a dotted line. Due to fluidic requirements, the direction of the gas jet 7 can also resemble or follow a hyperboloid 22, in particular a single-shell hyperboloid or a hyperboloid of rotation. The mass body 1 is separated due to the energy of the gas jet 7, in particular due to the kinetic energy of the moving gas. The continuation 20 is cut or separated by the special nozzle geometry and the special direction of the gas jet according to the invention and is deformed to a desired shaped cut surface 23. This is executed in the schematic diagram of FIG. 3, for example, as a rounded cut surface 23. The trailing of thread-shaped continuations is thus prevented.

In the diagram in FIG. 3 a mass residue 24 is retained on the closure 14 after the cutting process. This adheres to the closure 14 by adhesion or cohesion forces.

However, the retention of a mass residue 24 can also be prevented by suitable shaping of the closure 14 of an embodiment not shown. For example, as a result of a round, concave configuration of the tip of the closure 14, the gas jet can brush along the tip of the closure 14 in order to lift the mass residue 24 therefrom. In this alternative embodiment the gas jet is also present as a free jet. However, the gas jet sweeps along the contour of the gas nozzle and along the contour of the closure 14. In this embodiment the free jet is preferably wall-guided. Furthermore, the mass body here is not separated from the closure by the gas jet and not from the mass, as described in the further embodiments. The separation of the mass forming the mass body is accomplished by the closure.

Preferably in the method according to the invention, positions 1, 2 and 3 of FIGS. 1, 2 and 3 run through in ascending order.

FIG. 4 shows a detailed view of the apparatus according to the invention, in particular in the separating region 11. The apparatus comprises a gas nozzle 6 for dispensing a gas jet 7. The gas nozzle 6 has a tapering section 10. This tapering section brings about the focusing of the gas jet 7. However, it is also consistent with the inventive idea not to provide a tapering section and to configure the gas nozzle 6 as substantially straight, with parallel-running or opening walls. Distributor holes 18 open into the gas nozzle 6. Via these holes the gas flows from the distributor chamber 13 into the nozzle 6. According to the present embodiment of FIG. 4, the nozzle 6 is configured to be annular and/or conical. However, it is also consistent with the inventive idea to configure the nozzle as interrupted. Consequently the gas nozzle arrangement 39 is divided into several gas nozzles which are disposed, for example, along the circumference of the separating region 11. The provision of two gas nozzle acting against one another in a cross shape, which substantially give the same sectional view as the sectional view in FIG. 4 is consistent with the inventive idea.

The gas nozzle 6 opens into the gas nozzle outlet section 9 from which the gas can emerge. To this end the gas preferably enters into the free separating region 11. The mass 2 also emerges from the mass supply line 4 in the form of a free jet. According to the present embodiment, the gas nozzle outlet 9 is disposed in the immediate vicinity of the separating region 11.

The mass supply line 4 is substantially formed by a cladding tube 25 which extends in one or multiple parts to the mass outlet opening 38 and as far as the separating region 11. In the direction of the separating region 11 the cladding tube 25 has a tapering region 19. The outer wall 26 of the cladding tube 25 is sloping or conical in the direction of the separating region. The outer wall 26 forms a first wall of the gas nozzle 6 in this region. The second wall is formed by the inner side of the nozzle shell 27. The nozzle shell 27 is connected to the cladding tube 25 and has a cavity towards this, which substantially corresponds to the gas nozzle 6. The inner side of the nozzle shell 27 is also designed to be tapering or conical and forms the second nozzle wall of the gas nozzle 6. The inner wall of the nozzle shell 28 and the outer wall of the cladding tube 26 are thus disposed at a certain distance from one another. Preferably the two walls 26 and 28 approach one another in the direction of the gas nozzle outlet 9. As a result, the tapering section 10 is formed.

The cladding tube 25 is connected to the main body 30. Also connected to the main body 30 is the chamber ring 29. The chamber ring 29 here has an inside diameter which is greater than the outside diameter of the cladding tube 25 in the region of the chamber ring 29. Thus, an annular gap or an annular chamber is formed between the chamber ring 29 and the cladding tube 25. The cavity thereby formed is further delimited by the main body 30 and the nozzle shell 27. The cavity substantially forms the distributor chamber 13. An opening for connection of the pressure supply line 12 is provided in the chamber ring 29. Via the pressure supply line 12 the gas can be passed into the distributor chamber 13 and via distributor holes 18 into the gas nozzle 6. In the present embodiment the distributor holes are provided in a section of the nozzle shell 27. However, it is completely consistent with the inventive idea to execute these holes as free positions in other elements of the apparatus according to the invention. Furthermore it is also consistent with the inventive idea to design the chamber ring 29 and the nozzle shell 27 as one body.

For controlling and for regulating the gas pressure, a buffer storage device, a pressure regulator, a pressure measuring device, an air heating device and/or a flow regulator can be provided after the compressor. The gas flow can be controlled and/or regulated exactly by means of these regulating facilities. In the arrangement of nozzles directed towards one another or also with conically arranged nozzles, a portion of the gas jet can be deflected in the dispensing direction 3 due to dynamic effects of the gas jet. In order to avoid the negative effect of the uncontrolled deformation of the mass body 1, in such a case an exact adjustment of the control and/or regulating parameters of the gas flow is required. Thus, depending on the geometric configuration of the gas nozzle 6, the gas mass flow should be selected in such a manner that the partial gas mass flow deflected in the dispensing direction 3 has a speed in the region of the mass body which does not bring about any uncontrolled deformation. Advantageously the speed of the gas mass flow deflected in the dispensing direction in the region of the mass body is only slightly higher, the same or lower than the dispensing speed of the mass body 1.

According to one embodiment the gas pressure in the pressure supply line 12 can be about 0.1 to 3.5 bar. The gas volume flow in this case is variable from about 0.1 to 125 litres per minute and per gas nozzle. The opening time of the valve during which flow takes place through the gas nozzle 6 can be between 0.01 and 2 seconds.

The gas nozzle 6 has a certain cavity volume similar to the distributor chamber 13. This cavity volume serves in particular to distribute the pressure. In the embodiments shown the gap width of the gas nozzle outlet 9 can be, for example, between 0.1 and 0.8 mm. In particular, the required gap width is dependent on the viscosity of the mass to be cut.

The gas jet 7 is preferably guided transversely to the dispensing direction 3 in the direction of the mass 2. Angles of 90° to 45°, for example, are suitable for this purpose. This angle is measured between the direction of the gas jet 7 at the gas nozzle outlet 9 and the dispensing direction 3. Preferably the gas jet is inclined in the direction of movement of the mass, as shown in the figures.

FIG. 5 shows an apparatus according to the invention for the shaping dispensing of mass bodies from, for example, pumpable, viscous masses, comprising a nozzle arrangement 32 according to the preceding description and in particular according to the preceding FIGS. 1 to 4. Furthermore, the apparatus according to the invention comprises a transport surface 31 which in the present embodiment is designed as a belt conveyor. Furthermore, the apparatus comprises a pressure regulator 33, a pressure measuring device 35, a flow regulator 34, a gas valve 36 and a gas distributor 37.

Compressed gas is supplied from a compressor not shown via an adjustable valve 36. A pressure regulator 33 for regulating the incoming pressure and optionally a pressure measuring device 35 for measuring the pressure and a flow regulator 34 for regulating the gas mass flow are provided along the pressure supply line 12. The gas mass flow which is variable and/or adjustable via these means is introduced into a gas distributor 37. This gas distributor 37 substantially corresponds to a pressure buffer storage system which has a plurality of openings for distribution of the compressed gas to a plurality of nozzle arrangements 32. In the present view the gas distributor 37 has five outgoing pressure supply lines 12 which each lead to a nozzle arrangement 32. Consequently the embodiment of the apparatus according to the invention shown is suitable for simultaneously operating five nozzle arrangements 32 and therefore simultaneously dispensing in a shaping manner five mass bodies 1. As noted in the preceding description, the mass bodies 1 are placed on a transport surface 31 and removed. In the present FIG. 5 the mass bodies are shown schematically. The nozzle arrangements are disposed adjacent to one another according to the present embodiment. This means that they are disposed substantially along a straight line or along a region which runs transversely to the conveying direction of the mass bodies on the conveying surface. This enables a parallel and/or simultaneous dispensing of several mass bodies.

The method according to the invention is described further subsequently.

In a first step the mass 2 is guided through the mass supply line 4 in the direction of the dispensing region 5. The mass can, for example be conveyed by a mixer and a pump disposed downstream or upstream thereof. The mass 2 flows in the direction of the dispensing region 5 and emerges from the mass supply line 4 through a mass outlet opening. The mass is conveyed as long as the conveyance of the pump is maintained or as long as the closure 14 of the apparatus is opened. The closure 14 can be actuated by means of a suitable controller in order to close the mass supply line 4. If the desired quantity of mass 2 has emerged, the closure 14 is closed by means of the controller. To this end, in the present embodiment a piston 15 is moved in the dispensing direction 3. The sealing region 16 of the closure is thereby brought into operative contact with the sealing region 17 of the mass supply line in order to close the mass supply line 4.

The mass 2 which has emerged and/or the mass body 1 is subsequently applied, for example, to a conveyor belt, to a stationary surface, to a moving carrier body or a similar arrangement. Preferably the apparatus according to the invention has a certain distance from the surface to which the mass 2 is applied. In this region the mass 2 and/or the mass body 1 are present as a free jet. If the mass supply line 4 is closed by the closure 14, a valve is opened in order to pass gas via the pressure supply line 12 into the gas nozzle arrangement 39. To this end, in a first step the compressed gas is distributed in a distributor chamber 13, in a further step it is guided via distributor holes 18 into the gas nozzle 6, there optionally distributed once again and ultimately dispensed via a tapering section 10 and the gas nozzle outlet 9 preferably in a focused manner. The gas jet 7 or gas jets 7 thereby formed are directed onto the mass 2 or the mass body 1 in order to enable the desired shaping dispensing or shaping separating. In this case, gas jets outside the mass supply line are guided via a gas nozzle arrangement onto the mass. Preferably the gas jet are directed transversely to the mass dispensing direction onto the mass. In this case, the gas jets or the gas jet can be dispensed from several nozzles or from one nozzle. To improve the shaping it can be provided according to the invention that the gas jets are guided onto the mass, directed towards one another. Gas jets running in a cross shape, conically running gas jets and other forms of profile of the gas jets are possible in which a substantially symmetrical spatial body is formed by the gas jets. In particular, this symmetry is advantageous since a lateral deformation of the mass body in the cutting region is thereby avoided. The free jets, in particular the free-jet-shaped gas jets, can be jet-guided or wall-guided here. In the case of wall-guided gas jets, the gas jets sweep along a fixed object, for example, a cone.

When the mass body 1 is separated from the mass 2 or from the apparatus in a shaping manner, the closure 4 is opened again to form another mass body 1. The said steps are repeated subsequently.

According to the present invention, a plurality of apparatuses according to the invention, in particular nozzle arrangements, can be disposed adjacent to one another along a moving conveying surface. A plurality of nozzle arrangements can be supplied with compressed gas by a compressor.

The apparatus according to the invention and the method according to the invention are suitable and/or adapted to be used in-line in an industrial production plant for food products. Examples for products are elongate baked goods with rounded ends, chocolate bars, fillings of chocolate bars, cut confectionery, fillings of cut confectionery, dimensionally stable masses for sweets, dimensionally stable edible masses, dimensionally stable fillings of sweets etc. Optionally the apparatus according to the invention can also be used for shaping dispensing of dough, edible creams or ice creams.

### REFERENCE LIST

1. Mass body
2. Mass
3. Dispensing direction
4. Mass supply line
5. Dispensing region
6. Gas nozzle
7. Gas jet
8. Direction of gas jet
9. Gas nozzle outlet
10. Tapering section
11. Separating region
12. Pressure supply line
13. Distributor chamber
14. Closure
15. Piston
16. Sealing region of closure
17. Sealing region of mass supply line
18. Distributor hole
19. Tapering region of mass supply line
20. Continuation
21. Double cone
22. Hyperboloid
23. Cut surface
24. Mass residue
25. Cladding tube
26. Outer wall of cladding tube
27. Nozzle shell
28. Inner wall of nozzle shell
29. Chamber ring
30. Main body
31. Transport surface
32. Nozzle arrangement
33. Pressure regulator
34. Flow regulator
35. Pressure gauge
36. Valve
37. Gas distributor
38. Mass outlet opening
39. Gas nozzle arrangement

1-30. (canceled)

31. A nozzle configuration for the metered, shaping dispensing of mass bodies from pumpable, viscous or doughy masses, the configuration comprising:
a mass supply line defining a dispensing direction of the mass and of a mass body formed by the mass;
a mass outlet opening downstream of said mass supply line in said dispensing direction;
a separating region located outside said mass supply line for receiving the mass supplied by said mass supply line and passing through said mass outlet opening; and
a gas nozzle configuration for delivering at least one gas jet directed onto the mass located in said separating region and for the shaping separation of the mass body;
said gas nozzle configuration advancing the mass as a free jet in said separating region and cutting the mass by said at least one gas jet as the free jet in said separating region in which the mass leaves or has left said mass supply line; and
said gas nozzle configuration causing said at least one gas jet to impinge upon the mass transversely to said dispensing direction.

32. The nozzle configuration according to claim 31, wherein said gas nozzle configuration includes a gas nozzle being adapted for delivering a self-intersecting gas jet.

33. The nozzle configuration according to claim 31, wherein said gas nozzle configuration includes a plurality of nozzles being adapted for delivering gas jets directed towards one another.

34. The nozzle configuration according to claim 31, wherein:
said gas nozzle configuration includes a gas nozzle outlet forming a gas jet in the vicinity of said gas nozzle outlet travelling in a direction differing from said dispensing direction of the mass conveyed from said mass supply line into said separating region; and
said at least one gas jet runs transversely to said dispensing direction of the mass.

35. The nozzle configuration according to claim 31, wherein said at least one gas jet runs in a cross shape or follows a shape of a double cone, a hyperboloid, a single-shell hyperboloid or a hyperboloid of rotation.

36. The nozzle configuration according to claim 31, wherein said at least one gas jet in said separating region is directed as a free jet outside said mass supply line onto at least one of the mass or the mass body, and said free jet of said at least one gas jet is jet-guided or wall-guided.

37. The nozzle configuration according to claim 31, wherein said gas nozzle configuration includes at least one gas nozzle outlet surrounding at least one of the mass, said separating region or the mass supply line.

38. The nozzle configuration according to claim 31, wherein said gas nozzle configuration includes a gas nozzle outlet extending substantially annularly in the vicinity of said separating region around the mass.

39. The nozzle configuration according to claim 31, wherein said gas nozzle configuration includes a gas nozzle having a gas nozzle outlet, said gas nozzle having a tapering section in the direction of said gas nozzle outlet for focusing of said at least one gas jet.

40. The nozzle configuration according to claim 31, wherein said gas nozzle configuration includes a gas nozzle outlet constructed as an annular gap.

41. The nozzle configuration according to claim 40, wherein said annular gap is free from interruptions.

42. The nozzle configuration according to claim 31, wherein said gas nozzle configuration includes a pressure supply line, a distributor chamber downstream of said pressure supply line for distributing compressed gases, and a gas nozzle downstream of said distributor chamber.

43. The nozzle configuration according to claim 42, wherein said distributor chamber extends annularly around said mass supply line.

44. The nozzle configuration according to claim 31, which further comprises a closure for partially or completely closing said mass supply line to influence a mass flow of the mass.

45. The nozzle configuration according to claim 44, wherein said closure includes a movable piston.

46. The nozzle configuration according to claim 45, wherein at least one of said closure or said piston is disposed in said mass supply line.

47. The nozzle configuration according to claim 45, wherein said mass supply line has a sealing region, and said piston has a sealing region configured to be brought into operative contact with said sealing region of said mass supply line for closing said mass supply line.

48. An apparatus for the metered, shaping dispensing of mass bodies from pumpable, viscous or doughy masses, the apparatus comprising:
at least one nozzle configuration according to claim 29.

49. The apparatus according to claim 48, which further comprises a transport surface for transporting the mass bodies separated from the mass in a shaping manner.

50. The apparatus according to claim 49, wherein said at least one nozzle configuration is a plurality of nozzle configurations disposed adjacent one another in the vicinity of said transport surface.

51. The apparatus according to claim 50, which further comprises at least one pressure supply line receiving compressed gas or air from a compressor and supplying the compressed gas or air to said nozzle configurations or gas nozzle configurations.

52. The apparatus according to claim 48, which further comprises at least one of a regulating valve, a flow regulator or a pressure regulator for regulating a gas mass flow.

53. A method for the metered, shaping dispensing of mass bodies from pumpable, viscous masses, the method comprising the following steps:
a) conveying a mass in a mass supply line to a mass outlet opening;
b) conveying the mass through the mass outlet opening from the mass supply line into a separating region;
c) cutting and shaping the mass by using at least one gas jet in the separating region thus producing a mass body; and
d) causing the mass and the at least one gas jet to impinge upon one another as free jets for separation of the mass body from the mass.

54. The method according to claim 53, which further comprises:
providing a nozzle configuration producing the at least one gas jet; and
carrying out the step of cutting and shaping the mass by using the at least one gas jet outside the nozzle configuration.

55. The method according to claim 53, which further comprises delivering the at least one gas jet at least one of transversely to a dispensing direction of the mass or substantially in a cross shape.

56. The method according to claim 53, which further comprises causing the at least one gas jet to follow a shape of a double cone, a hyperboloid, a single-shell hyperboloid or a hyperboloid of rotation.

57. The method according to claim 53, which further comprises stopping the conveyance of the mass into a dispensing region by actuating a closure before or at an exit of the at least one gas jet.

58. The method according to claim 53, which further comprises interrupting the conveyance of the mass by moving a piston in a dispensing direction of the mass until a sealing region of the piston makes a sealing linear contact, a surface contact or a circular contact with a sealing region of the mass supply line.

59. The method according to claim 53, which further comprises:
supplying at least one mass to a plurality of nozzle configurations;
separating and shaping mass bodies by using the nozzle configurations; and
removing the mass bodies on a transport surface.
